(19) United States
(12) Patent Application Publication
(10) Pub. No.: US 2025/0120377 A1
(43) Pub. Date: Apr. 17, 2025

(54) SAND RAKE

(71) Applicant: Xue-feng Chen, Guangzhou City (CN)

(72) Inventor: Xue-feng Chen, Guangzhou City (CN)

(21) Appl. No.: 18/378,659

(22) Filed: Oct. 11, 2023

(51) Int. Cl. A01K 80/00; A01D 7/00; A01K 79/00

(52) U.S. Cl. CPC A01K 80/00; A01D 7/00; A01K 79/00

(57) ABSTRACT

The sand rake of the present invention includes: a filter body, having an open filtering space and a plurality of filtering holes distributed across all sides thereof, a front side of the filter body being formed as an inclined surface and having a top edge with a plurality of teeth, while a bottom side of the filter body being formed as a flat surface; a support component, disposed in the filtering space of the filter body; and a handle, disposed at a rear side of the filter body. Accordingly, by using the specially-structured filter body of the sand rake, it replaces the user's hand in collecting shellfish organisms, increasing the harvest yield and enhancing safety during use.

### BACKGROUND OF THE INVENTION

### Fields of the Invention

The present invention relates to a collecting tool and, more particularly to, a sand rake used for collecting shellfish and similar organisms on the beach.

### Descriptions of Related Art

In recent years, the tourism industry in our country has been thriving, and the travel frequency on holidays has been increasing. Among these activities, beachcombing for shellfish and similar organisms is particularly popular among the people. Typically, people use their hands directly to search for these organisms in the sand. However, because the shells of these organisms are quite sharp, it is easy for hands to be cut during the collection process. Additionally, this method is physically demanding and yields relatively little harvest. As a result, many individuals resort to using pry bars or clamps to pick out the shellfish from the sand before collecting them, but this method is highly inefficient.

Furthermore, when people leave the beach area, they often leave behind a significant amount of trash on the beach, and after high tide, many dead organisms such as shellfishs and crustaceans are left on the beach, negatively affecting its aesthetics. However, currently, there is no ideal tool for collecting shellfish and similar organisms on the beach.

### SUMMARY OF THE INVENTION

The primary objective of the present invention is to provide a sand rake with a filter body configured into a special structure to enhance overall strength and designed with a slopped front side in combined with jagged teeth to allow users to save effort and increase work efficiency when digging for shellfish and similar organisms.

To achieve the above objective, the sand rake of the present invention includes: a filter body, having an open filtering space and a plurality of filtering holes distributed across all sides thereof, wherein a front side of the filter body is formed as an inclined surface and has a top edge with a plurality of teeth, while a bottom side of the filter body is formed as a flat surface; a support component, disposed in the filtering space of the filter body; and a handle, disposed at a rear side of the filter body. Accordingly, by using the specially-structured filter body of the sand rake, it replaces the user's hand in collecting shellfish and similar organisms, increasing the harvest yield and enhancing safety during use.

In the present invention, the support component has a sloping end and a straight end at both ends thereof, respectively. The sloping end is installed at the first side of the filter body and corresponds to the inclination angle of the inclined surface at the first side, while the straight end is installed at the rear side of the filter body.

In the present invention, the handle is constituted by an upper rod, a lower rod and a middle rod connecting the upper rod and the lower rod, and the upper rod, the lower rod and the middle rod are configured as a detachable structure.

In the present invention, the adjacent teeth are connected by a plurality of concave grooves, and both a top edge of each of the teeth and a bottom edge of each of the grooves are designed to be flat surfaces.

In the present invention, the teeth of the filter body are generally serrate and are arranged in a uniform spacing configuration.

### BRIEF DESCRIPTION OF THE DRAWINGS

FIG. 1 is a partially exploded perspective view of the present invention.

FIG. 2 is another partially exploded perspective view of the present invention.

FIG. 3 is an assembled perspective view of the present invention.

FIG. 4 is another assembled perspective view of the present invention from another angle.

FIG. 5 is an assembled view for illustrating the inclined surface of the filter body and the sloping end of the support component of the present invention.

FIG. 6 is a side view of the present invention.

FIG. 7 is a perspective view for illustrating a shorter handle of the present invention.

FIG. 8 is an assembled view for illustrating a single horizontal member used as the support component and the filter body of the present invention.

FIG. 9 is a schematic view (I) of the use state of the present invention.

FIG. 10 is a schematic view (II) of the use state of the present invention.

FIG. 11 is a schematic view (IIII) of the use state of the present invention.

### DETAILED DESCRIPTION OF THE PREFERRED EMBODIMENT

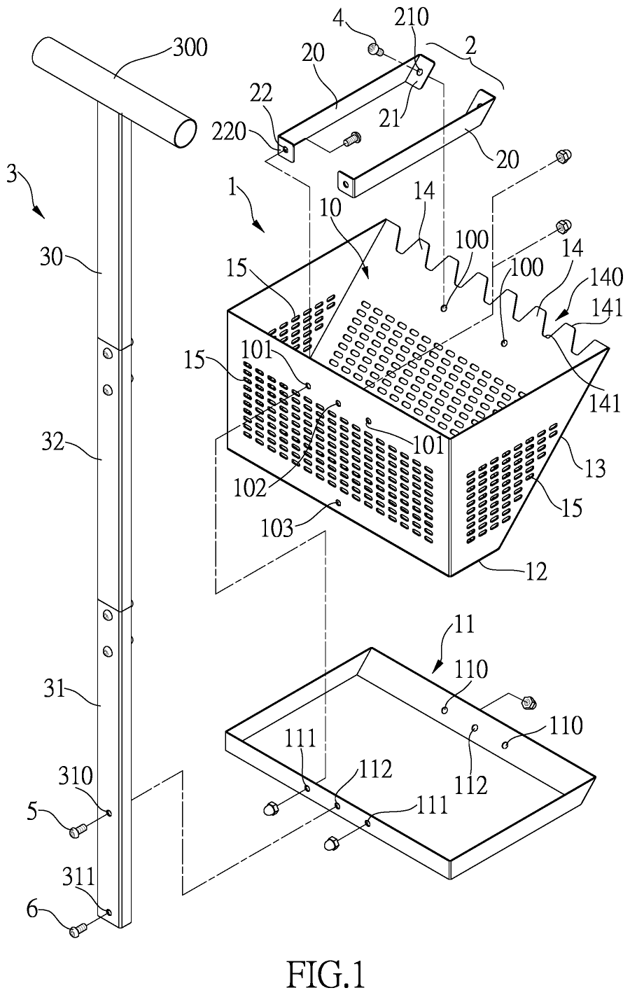

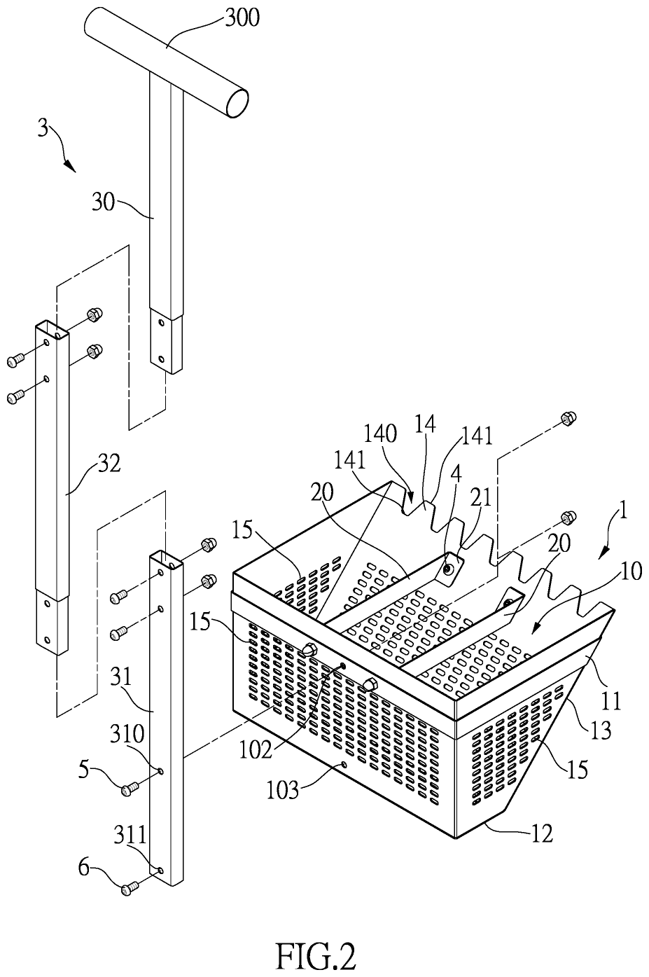

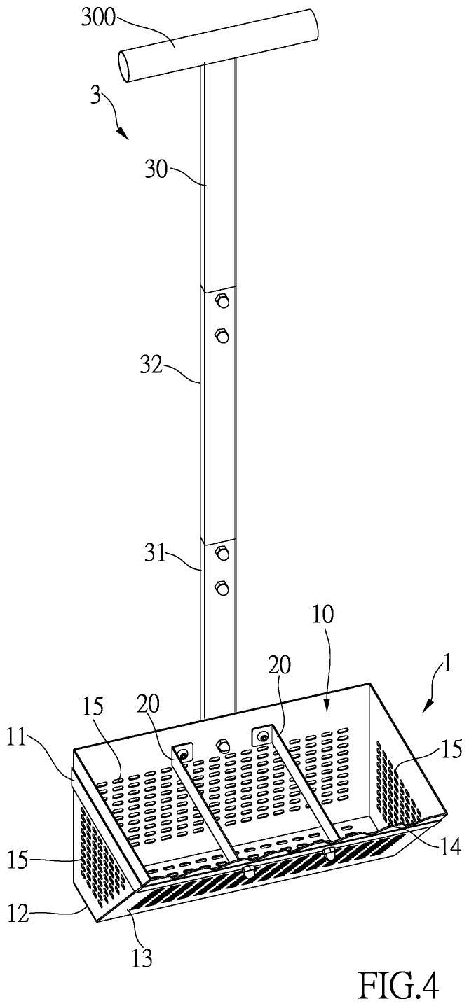

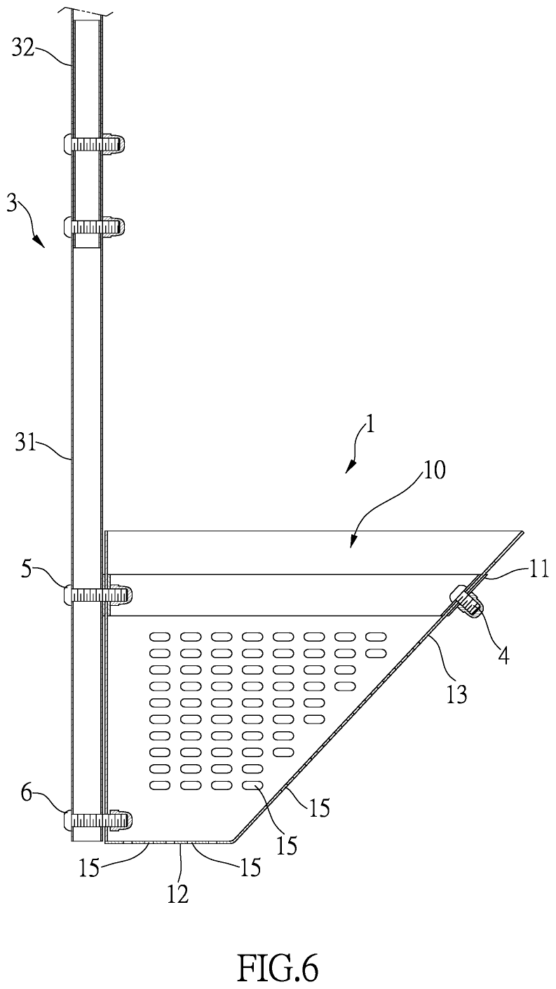

Please referring to FIGS. 1 to 11, the present invention provides a sand rake for picking up shellfish organisms T1 on the beach T. The sand rake includes a generally trapezoidal and broad filter body 1, which has an open filtering space 10 and is surrounded by a frame-shaped reinforcement piece 11 around all outer sides thereof. The reinforcement piece 11 is provided with at least one first mounting hole 110 at its front side, at least one second mounting hole 111 at its rear side, and at least one third mounting hole 112 between two second mounting holes 111. Additionally, the filter body 1 is provided with at least one fourth mounting hole 100 at its front side, at least one fifth mounting hole 101, at least one sixth mounting hole 102, and at least one seventh mounting hole 103 at its front and rear sides, respectively. The at least one fourth mounting hole 100 corresponds to the at least one first mounting hole 110 on the reinforcement piece 11. The at least one fifth mounting hole 101 corresponds to the at least one second mounting hole 111 on the reinforcement piece 11. The at least one sixth mounting hole 102 corresponds to the at least one third mounting hole 112 on the reinforcement piece 11. Furthermore, the bottom side of the filter body 1 is formed as a flat surface 12, while the front side is formed as an inclined surface 13 and has a top edge with a plurality of teeth 14. The teeth 14 are generally serrate in a sand shovel style and are arranged in a uniform spacing configuration. A plurality of concave grooves 140 connect the adjacent teeth 14, and both the top edge of the teeth 14 and the bottom edge of the grooves 140 are designed to be flat surfaces 141. The filter body 1 has a plurality of filtering holes 15 distributed across all sides thereof.

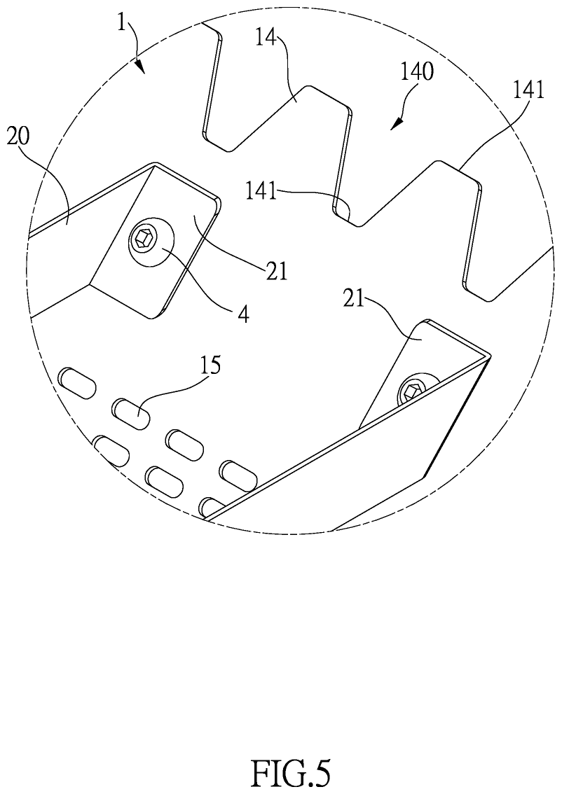

The sand rake further includes a support component 2 consisting of at least one horizontal member 20 and positioned within the filtering space 10 of the filter body 1. The support component 2 has a sloping end 21 and a straight end 22 at its two ends, respectively. The sloping end 21 corresponds to the inclination angle of the inclined surface 13 at the front side of the filtering space 10 (as shown in FIG. 5), so that the sloping end 21 and straight end 22 of the support component 2 can correspond to and be disposed on the front side and rear side of the filter body 1, respectively. The sloping end 21 of the support component 2 is provided with at least one eighth mounting hole 210, corresponding to the at least one fourth mounting hole 100 on the front side of the filter body 1 and the at least one first mounting hole 110 on the reinforcement piece 11. The straight end 22 of the support component 2 is provided with at least one ninth mounting hole 220, corresponding to the at least one fifth mounting hole 101 on the rear side of the filter body 1 and the at least one second mounting hole 111 on the reinforcement piece 11.

Moreover, the sand rake of the present invention further includes a handle 3, installed on the rear side of the filter body 1. The handle 3 is constituted by an upper rod 30, a lower rod 31, and a middle rod 32 connecting the upper rod 30 and the lower rod 31. The upper rod 30, the lower rod 31 and the middle rod 32 are configured as a detachable structure. The top end of the upper rod 30 is equipped with a T-shaped grip 300. The lower rod 31 is provided with at least one tenth mounting hole 310 and at least one eleventh mounting hole 311. The at least one tenth mounting hole 310 on the lower rod 31 corresponds to the at least one third mounting hole 112 on the reinforcement piece 11 and the at least one sixth mounting hole 102 on the rear side of the filter body 1. The at least one eleventh mounting hole 311 on the lower rod 31 corresponds to the at least one seventh mounting hole 103 on the rear side of the filter body 1.

During assembly, first, at least one first mounting member 4 is assembled into the at least one eighth mounting hole 210 and the ninth mounting hole 220 on the support component 2, the at least one fourth mounting hole 100 and the at least one fifth mounting hole 101 on the filter body 1, and the at least one first mounting hole 110 and the at least one second mounting hole 111 on the reinforcement piece 11. As such, the support component 2 can be assembled within the filtering space 10 of the filter body 1, and the reinforcement piece 11 surrounds and is assembled on the outer side of the filter body 1.

Additionally, at least one second mounting member 5 is threaded through the at least one tenth mounting hole 310 on the lower rod 31 of the handle 3, the at least one third mounting hole 112 on the reinforcement piece 11, and the at least one sixth mounting hole 102 on the filter body 1. Then, at least one third mounting member 6 is threaded through the at least one eleventh mounting hole 311 on the lower rod 31 of the handle 3 and the at least one seventh mounting hole 103 on the filter body 1.

By the aforementioned assembly, the handle 3, the reinforcement piece 11, the support component 2 and the filter body 1 are assembled into a stable fixed relationship. The bottom side of the filter body 1 is designed as a flat surface 12, allowing the sand rake to stand upright and saving storage space.

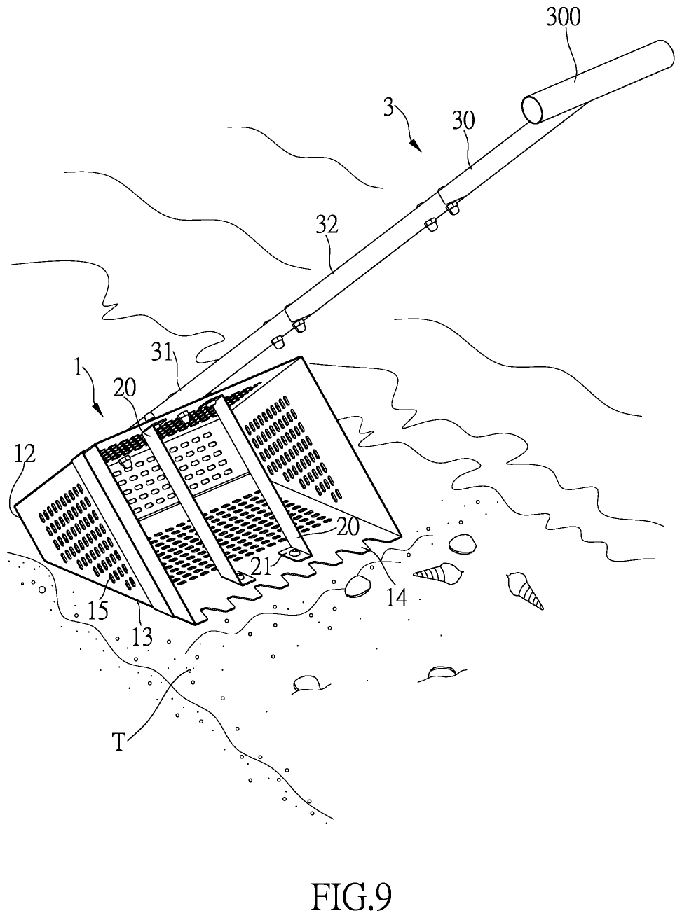

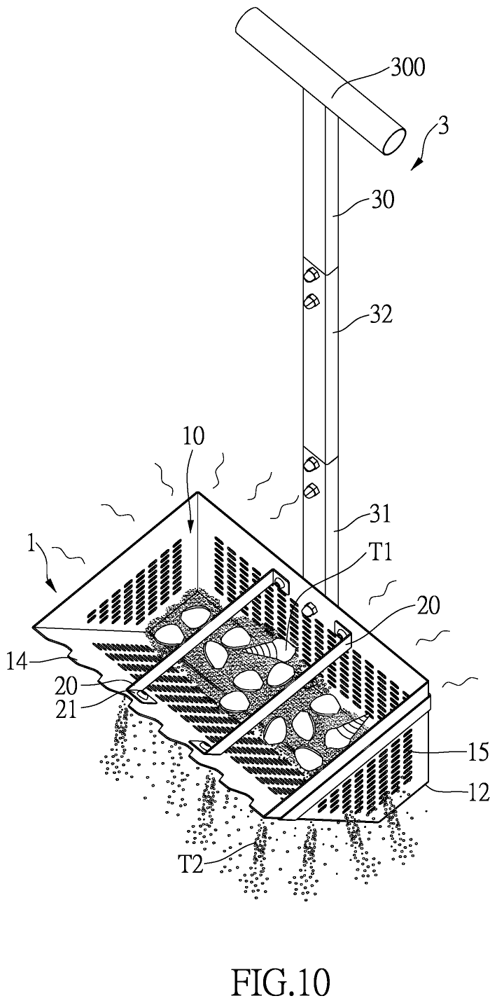

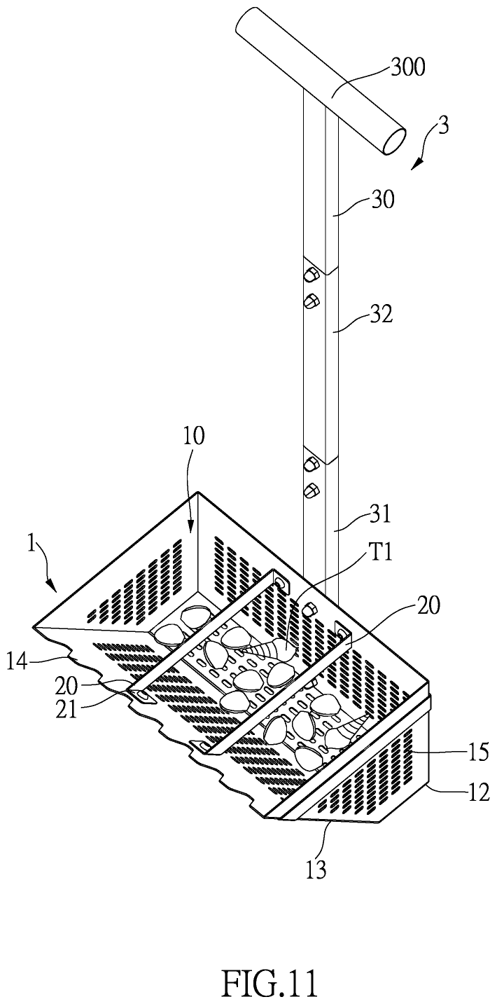

Further illustration of the operating procedure, the user can tilt the filter body 1 by holding the grip 300 and direct the top edge of the plurality of teeth 14 towards the beach T to press the inclined surface 13 at the front side of the filter body 1 against the beach T (as shown in FIG. 9), followed by back-and-forth motion to dig into the beach T. Once there are shellfish organisms T1 in the path of the filter body 1, they will be exposed on the surface of the beach T and collected into the filtering space 10 of the filter body 1 as the teeth 14 on the top edge of the filter body 1 pass over them. When shellfish organisms T1 are collected, the user can lift the handle 3 and the filter body 1 upward. After the filtering space 10 of the filter body 1 contains a certain quantity of shellfish organisms T1, the filter body 1 can be immersed in seawater for washing. This process allows sand and mud T2 on the surface of the shellfish organisms T1 to flow out of the filter body 1 along with seawater through the plurality of filtering holes 15 (as shown in FIG. 10), leaving only the shellfish organisms T1 in the filtering space 10 of the filter body 1 (as shown in FIG. 11). This procedure can be repeated to effectively collect shellfish organisms T1 from the beach T.

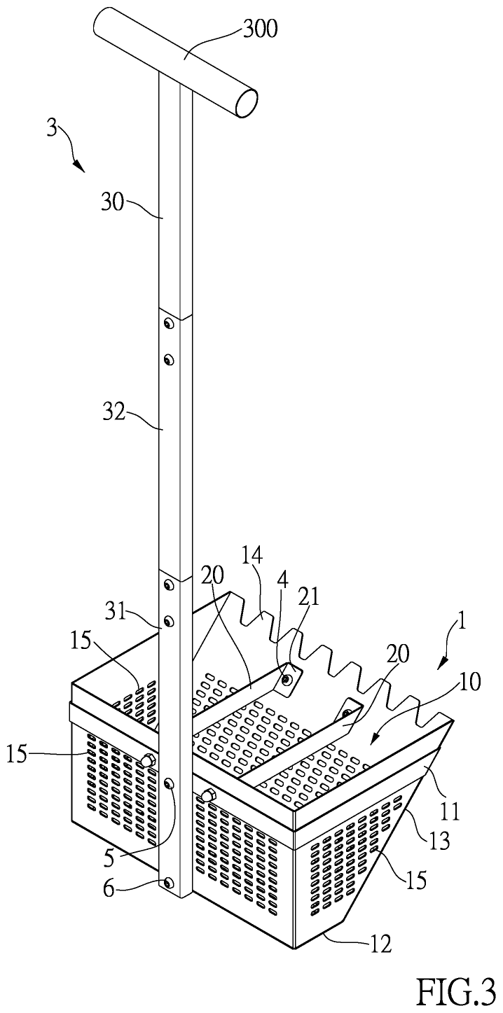

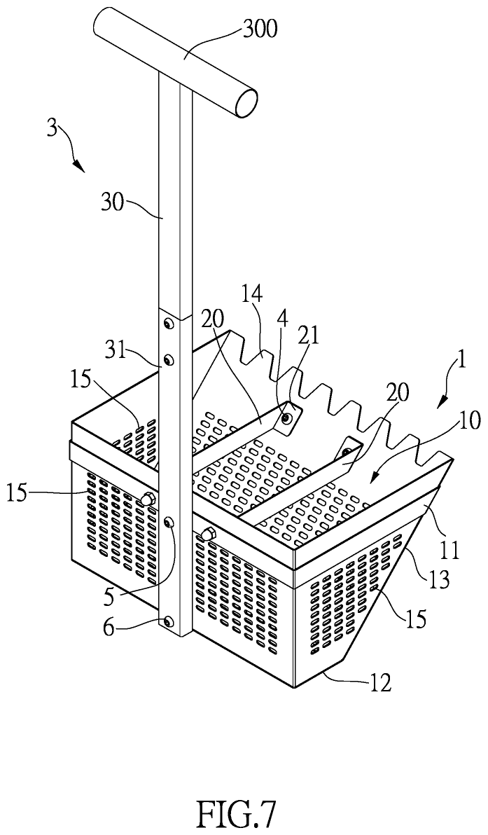

It is worth mentioning that the handle 3 is designed as a detachable structure, consisting of the upper rod 30, the lower rod 31 and the middle rod 32. Therefore, users can adjust the length of the handle 3 as needed during excavation. When it is necessary to shorten the handle 3, the assembly of the middle rod 32 can be omitted (as shown in FIG. 7), and only the upper rod 30 and the lower rod 31 need to be assembled. On the contrary, if it is necessary to increase the length of the handle 3, the middle rod 32 can be assembled between the upper rod 30 and the lower rod 31 (as shown in FIG. 3). Moreover, there is no limitation to having only a single middle rod 32. Additionally, in the present invention, the top of the handle 3 is designed with an ergonomically T-shaped grip 300 for power-saving and enhanced maneuverability during the operation of the handle 3. This design significantly reduces perceived weight and fatigue, even during extended periods of collecting shellfish organisms T1, thus improving collection efficiency. Furthermore, the entire sand rake of the present invention is made of 304 stainless steel material, ensuring resistance to oxidation even when exposed to seawater.

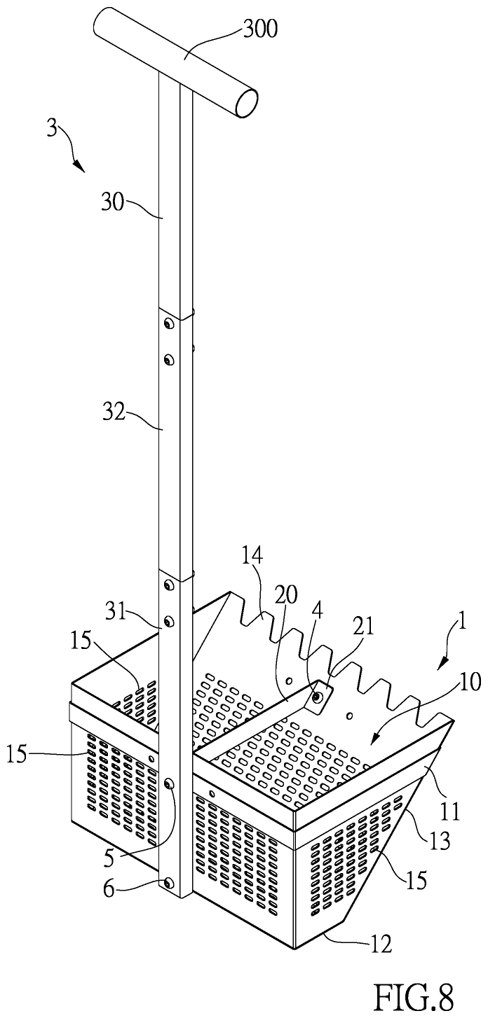

In addition, the support component 2 assembled within the filtering space 10 of the filter body 1 can further increase the overall strength of the filter body 1. The quantity of the support component(s) 2 can be chosen based on practical considerations. As shown in FIG. 3, two horizontal members 20 are used as the support components 2 and assembled inside the filter body 1, while as shown in FIG. 8, a single horizontal member 20 is used as the support component 2 and assembled inside the filter body 1. The present invention prefers the use of two horizontal members 20 for assembly, but it is not limited thereto.

In summary, the sand rake of the present invention offers the following advantages compared to the prior art.

First, the special structure of the filter body 1 of the sand rake replaces the need for using one's hand to pick up shellfish organisms. This not only allows for the excavation of a larger area, increasing the yield, but also prevents injury to the hand from shellfish organisms T1, thus improving efficiency and safety.

Second, the handle 3 of the sand rake is designed with a detachable structure, allowing users to adjust its length according to the situation.

This can prevent users from bending over excessively when the handle 3 is too long, saving energy. Additionally, the filter body 1 with serrated teeth 14 allows for quick and efficient excavation. The multiple filtering holes 15 in the filter body 1 allow sand and mud to flow out, avoiding prolonged immersion of the user's hand in seawater and increasing comfort.

It should be noted that in this disclosure, the terms such as “first” and “second” are used to distinguish one entity or operation from another and do not necessarily require or imply any actual relationship or sequence between these entities or operations. Furthermore, the terms such as “comprise”, “include” or any of their variations are intended to encompass non-exclusive inclusion, meaning that processes, methods, items, or devices comprising a series of elements include not only those elements explicitly listed but also other elements that are not explicitly listed or inherent to such processes, methods, items, or devices. Additionally, in the diagrams of the present invention, the elements are provided for the purpose of illustrating the technical means of the present invention clearly and do not imply any other limitations.

What is claimed is:

1. A sand rake, comprising:
a filter body, having an open filtering space and a plurality of filtering holes distributed across all sides thereof, wherein a front side of the filter body is formed as an inclined surface at an inclination angle and has a top edge with a plurality of teeth, while a bottom side of the filter body is formed as a flat surface;
a support component, disposed in the filtering space of the filter body and having a sloping end and a straight end at both ends thereof, respectively, wherein the sloping end is installed at the first side of the filter body and corresponds to the inclination angle of the inclined surface at the first side, while the straight end is installed at a rear side of the filter body; and
a handle, disposed at the rear side of the filter body.

2. The sand rake as claimed in claim 1, wherein the support component is constituted by at least one horizontal member.

3. The sand rake as claimed in claim 2, wherein the filtering space of the filter body is assembled with a single horizontal member serving as the at least one horizontal member.

4. The sand rake as claimed in claim 2, wherein the filtering space of the filter body is assembled with two horizontal members serving as the at least one horizontal member.

5. The sand rake as claimed in claim 1, wherein (i) outer sides of the filter body are surrounded by a frame-shaped reinforcement piece, (ii) the reinforcement piece is provided with at least one first mounting hole, at least one second mounting hole and at least one third mounting hole at front and rear sides thereof, respectively, (iii) the filter body is provided with at least one third mounting hole, at least one fourth mounting hole, at least one fifth mounting hole, at least one sixth mounting hole and at least one seventh mounting hole at the front side and the rear side thereof, respectively, (iv) the at least one fourth mounting hole corresponds to the at least one first mounting hole on the reinforcement piece, (v) the at least one fifth mounting hole corresponds to the at least one second mounting hole on the reinforcement piece, and (vi) the at least one sixth mounting hole corresponds to the at least one third mounting hole on the reinforcement piece.

6. The sand rake as claimed in claim 5, wherein the sloping end of the support component is provided with at least one eighth mounting hole corresponding to the at least one fourth mounting hole on the front side of the filter body and the at least one first mounting hole on the reinforcement piece, and the straight end of the support component is provided with at least one ninth mounting hole corresponding to the at least one fifth mounting hole on the rear side of the filter body and the at least one second mounting hole on the reinforcement piece.

7. The sand rake as claimed in claim 5, wherein the handle is constituted by an upper rod, a lower rod and a middle rod connecting the upper rod and the lower rod, and the upper rod, a lower rod and a middle rod are configured as a detachable structure.

8. The sand rake as claimed in claim 7, wherein (i) the lower rod is provided with at least one tenth mounting hole and at least one eleventh mounting hole, (ii) the at least one tenth mounting hole corresponds to the at least one third mounting hole on the reinforcement piece and the at least one sixth mounting hole on the rear side of the filter body, and (iii) the at least one eleventh mounting hole on the lower rod corresponds to the at least one seventh mounting hole on the filter body.

9. The sand rake as claimed in claim 1, wherein the adjacent teeth are connected by a plurality of concave grooves.

10. The sand rake as claimed in claim 9, wherein both a top edge of each of the teeth and a bottom edge of each of the grooves are designed to be flat surfaces.

11. The sand rake as claimed in claim 1, wherein the filter body, when viewed from the side, exhibits a broad trapezoidal shape.

12. The sand rake as claimed in claim 1, wherein the teeth of the filter body are generally serrate and arranged in a uniform spacing configuration.
